(19) United States
(12) Patent Application Publication
(10) Pub. No.: US 2024/0004830 A1
(43) Pub. Date: Jan. 4, 2024

(54) FLOORPLAN-OPTIMIZED MATRIX EXTENSION ARCHITECTURE FOR PROCESSORS

(71) Applicant: Alibaba (China) Co., Ltd., Hangzhou (CN)

(72) Inventors: Qichen ZHANG, Shanghai (CN); Lide DUAN, Sunnyvale, CA (US); Shengcheng WANG, Shanghai (CN)

(21) Appl. No.: 17/982,450

(22) Filed: Nov. 7, 2022

(30) Foreign Application Priority Data
Jul. 1, 2022 (CN) 202210773612.9

(51) Int. Cl. G06F 15/80; G06F 9/54; G06F 7/50; G06F 7/523

(52) U.S. Cl. CPC G06F 15/8046; G06F 9/544; G06F 7/50; G06F 7/523

(57) ABSTRACT

Embodiments of the present disclosure includes a processor. The processor may include a systolic array of processing elements; a first group of buffers coupled to the systolic array, wherein the first group comprises one or more first buffers; a second group of buffers coupled to the systolic array, wherein the second group comprises one or more second buffers; an accumulator coupled to the systolic array; and a third group of buffers coupled to the accumulator, wherein the third group comprises one or more third buffers.

### CROSS-REFERENCE TO RELATED APPLICATION

This application claims priority to and benefits of Chinese patent Application No. 202210773612.9, filed with the China National Intellectual Property Administration (CNIPA) on Jul. 1, 2022. The entire contents of the above-identified application are incorporated herein by reference.

### TECHNICAL FIELD

The disclosure relates generally to central processing unit (CPU) architecture, and more specifically, to floorplan-optimized matrix extension architecture for CPUs.

### TRADEMARK NOTICE

All trademarks used herein are the property of their respective trademark owners.

### BACKGROUND

Power, Performance, and Area (PPA) are three major components for evaluating CPU performance the processor technology. PPA characterizes the physical constraints and available resources of integrated circuits. Different tradeoffs between the three variables allow for different circuit optimizations. As CPUs are increasingly used for artificial intelligence (AI) and other new applications, it is desirable to improve their architecture to improve PPA and other performance metrics.

### SUMMARY

Various embodiments of the present specification may include systems with floorplan-optimized matrix extension architecture and corresponding methods.

According to one aspect, a processor includes a systolic array of processing elements; a first group of buffers coupled to the systolic array, wherein the first group comprises one or more first buffers; a second group of buffers coupled to the systolic array, wherein the second group comprises one or more second buffers; an accumulator coupled to the systolic array; and a third group of buffers coupled to the accumulator, wherein the third group comprises one or more third buffers.

In some embodiments, the processor is a central processing unit (CPU).

In some embodiments, the first group includes two buffers, the second group comprises two buffers, and the third group comprises four buffers.

In some embodiments, the first group comprises a first plurality of buffers individually coupled to the systolic array; and the second group comprises a second plurality of buffers individually coupled to the systolic array.

In some embodiments, the systolic array is a two-dimensional array; the two-dimensional array corresponds to a first side, a second side, a third side opposite to the first side, and a fourth side opposite to the second side; and the first plurality of buffers are individually coupled to the first side and not coupled to the second side, the third side, and the fourth side.

In some embodiments, the second plurality of buffers are individually coupled to the second side or third side and not coupled to the first side and the fourth side.

In some embodiments, the accumulator is coupled to the fourth side and not coupled to the first side, the second side, and the third side.

In some embodiments, the first plurality of buffers are individually coupled to one or more caches of the processor; and the second plurality of buffers are individually coupled to the one or more caches of the processor.

In some embodiments, the first plurality of buffers are configured to obtain first input data from the one or more caches of the processor and to transmit the first input data to the systolic array; and the first plurality of buffers are configured to, in parallel and staggered in time, each transmit a portion of the first input data the systolic array.

In some embodiments, the second plurality of buffers are configured to obtain weight data from the one or more caches of the processor and to preload the weight data into the systolic array.

In some embodiments, the systolic array is configured to compute based on the first input data and the weight data and to, in parallel and staggered in time, transmit output data to the accumulator.

In some embodiments, the third group comprises a third plurality of buffers coupled to (i) the accumulator and (ii) one or more caches of the processor.

In some embodiments, the first plurality of buffers are coupled in parallel to the systolic array; the second plurality of buffers are coupled in parallel to the systolic array; the third plurality of buffers are connected in series within the third group; and the third plurality of buffers and the accumulator form a loop.

In some embodiments, the third plurality of buffers are configured to obtain second input data from the one or more caches of the processor, and transmit the second input data to the accumulator; and the accumulator is configured to recursively generate an intermediary result based on output data from the systolic array and the second input data, and transmit the intermediary result to the third plurality of buffers.

In some embodiments, the third plurality of buffers are configured to feedback the intermediary result to the accumulator; and the accumulator is configured to recursively update the intermediary result based on the output data and the feedback intermediary result and transmit the updated intermediary result to the third plurality of buffers.

In some embodiments, the third plurality of buffers are configured to each store a last updated intermediary result, and output a final result comprising the last updated intermediary results to the one or more caches of the processor.

In some embodiments, the first plurality of buffers are configured to obtain a first matrix A and feed the first matrix A to the systolic array; the second plurality of buffers are configured to obtain a second matrix B and feed the second matrix B to the systolic array; the systolic array is configured to multiply the first matrix A and the second matrix B to output A*B to the accumulator; the accumulator is configured to obtain a third matrix C from the third plurality of buffers and generate a result of A*B+C through a plurality of loops of recursive calculations; and the third plurality of buffers are configured to obtain and output the result of A*B+C.

According to another aspect, a computing device includes a memory and a processor coupled to the memory. The processor includes a systolic array of processing elements; a first group of buffers coupled to the systolic array, wherein the first group comprises one or more first buffers configured to pipeline first input data into the systolic array; a second group of buffers coupled to the systolic array, wherein the second group comprises one or more second buffers configured to broadcast weight data into the systolic array; an accumulator coupled to the systolic array and configured to receive output data from the systolic array; and a third group of buffers comprising one or more third buffers configured to transmit second input data to the accumulator via a first pathway of a data transmission loop and receive results from the accumulator via a second pathway of the data transmission loop.

In some embodiments, the third group of buffers are coupled to the accumulator.

In some embodiments, the processor further comprises a cache; and the third group of buffers are coupled to the cache.

According to another aspect, a method may include (1) storing, by a first group of buffers of a processor, at least one or more first elements of a first matrix, the first group of buffers comprising one or more first buffers; (2) storing, by a second group of buffers of the processor, at least one or more second elements of a second matrix, the second group of buffers comprising one or more second buffers; (3) obtaining, by a systolic array of the processor, the one or more first elements of the first matrix from the first group of buffers and the one or more second elements of the second matrix from the second group of buffers, the systolic array comprising processing elements coupled to the first group of buffers and the second group of buffers; (4) multiplying, by the systolic array, the one or more first elements with the one or more second to generate one or more intermediary values; (5) obtaining, by a third group of buffers of the processor, a third matrix; (6) obtaining, by an accumulator of the processor, one or more third elements of the third matrix from the third group of buffers and the one or more intermediary values from the systolic array; (7) adding, by the accumulator, the one or more third elements with the one or more intermediary values to obtain an intermediary sum; (8) transmitting, by the accumulator, the intermediary sum to the third group of buffers; (9) storing, by the third group of buffers, the intermediary sum as the one or more third elements of the third matrix; and (10) recursively performing, by the processor, at least steps (3)-(9) until a final result is stored to the third group of buffers, wherein the final result corresponds to a sum of the third matrix and a product between the first matrix and the second matrix.

These and other features of the systems, methods, and hardware devices disclosed, and the methods of operation and functions of the related elements of structure and the combination of parts and economies of manufacture will become more apparent upon consideration of the following description and the appended claims referring to the drawings, which form a part of this specification, where like reference numerals designate corresponding parts in the figures. It is to be understood, however, that the drawings are for illustration and description only and are not intended as a definition of the limits of the invention.

### BRIEF DESCRIPTION OF THE DRAWINGS

FIG. 1 illustrates an exemplary schematic diagram of a computing device with floorplan-optimized matrix extension architecture, in accordance with some embodiments.

FIG. 2 illustrates an exemplary schematic diagram of a matrix extension unit, in accordance with some embodiments.

FIG. 3A illustrates an exemplary schematic diagram of a matrix extension unit, in accordance with some embodiments.

FIG. 3B illustrates an exemplary schematic diagram of buffer coupling, in accordance with some embodiments.

FIG. 3C illustrates an exemplary schematic diagram of pipelined input, in accordance with some embodiments.

FIG. 3D illustrates an exemplary schematic diagram of pipelined input, in accordance with some embodiments.

FIG. 4 illustrates an exemplary method of performing matrix computation, in accordance with some embodiments.

FIG. 5 illustrates an exemplary block diagram of a matrix extension unit, in accordance with some embodiments.

### DETAILED DESCRIPTION

The specification is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present specification. Thus, the specification is not limited to the embodiments shown but is to be accorded the widest scope consistent with the principles and features disclosed herein.

In various embodiments, the matrix extension architecture of a processor may include hardware components and logic for supporting a packed data instruction set extension, which has applications in areas such as light-weight artificial intelligence (AI) computation. The matrix extension architecture may improve the functions of processors by providing the flexibility of offloading some computations (e.g., matrix multiplications), which may be inefficient or take longer time for processors to execute without the matrix extension architecture.

Floorplan is an important aspect to consider when designing matrix extension architecture with processors such as CPUs. Floorplan may refer to a schematic representation of tentative placement of the major functional blocks of the processor, and it affects the physical configurations and performance of the processor. Matrix extensions and systolic arrays in existing CPU designs have various drawbacks. For example, the calculation ability of matrix extensions based on outer-product is limited, such that the largest matrix it can calculate is 4×4 for FP16 (half precision) data. For another example, tile registers in the systolic array accelerator of Intel™ Advanced Matrix Extension (AMX) have the same function and are not optimized for circuit floorplan. That is, each tile register is not fixed to a connection with a corresponding part of the systolic array, and instead has multiple connections with different parts of the systolic array through selectors, which allow selection of one of the connections through software for performing a specific computation. The additional connections and selectors would increase the size of CPU or otherwise lower the PPA. In yet another example, instead of using systolic array, IBM™ matric math assist (MMA) uses two kinds of data buffers coupled to an outer-product architecture which takes up more space and computes at a lower frequency than systolic array. Thus, systolic array is a better option for larger computation units.

To optimize the floorplan, the matrix extension needs to have a high degree of data reuse, because frequent data read/write among memory, cache, and matrix extension increases delay and power consumption. Further, since the matrix extension circuit is placed inside the CPU cores, its size should be minimized to lower the CPU size. Thus, the floorplan dictating the physical arrangement and physical connections among different hardware components in CPU should be optimized.

In various embodiments, the disclosed systems and methods may improve the floorplan of processors including matrix extension based on systolic array. The matrix extension in CPU cores may contain one or more small computation units and one or more grouped data buffers for iterative computations. The disclosed architecture may achieve compact floorplan design with better PPA and achieve lower power for data load and store by high data-reuse between data buffers. The disclosed floorplan-optimized architecture may be applied in powerful CPU cores as a matrix extension or applied in efficient system-on-chip (SoC) as an AI accelerator, such as performing additions and/or multiplications of large matrices in deep learning or other applications and enabling small General Matrix Multiplication acceleration. The optimized floorplan is compact, so the architecture may achieve better PPA.

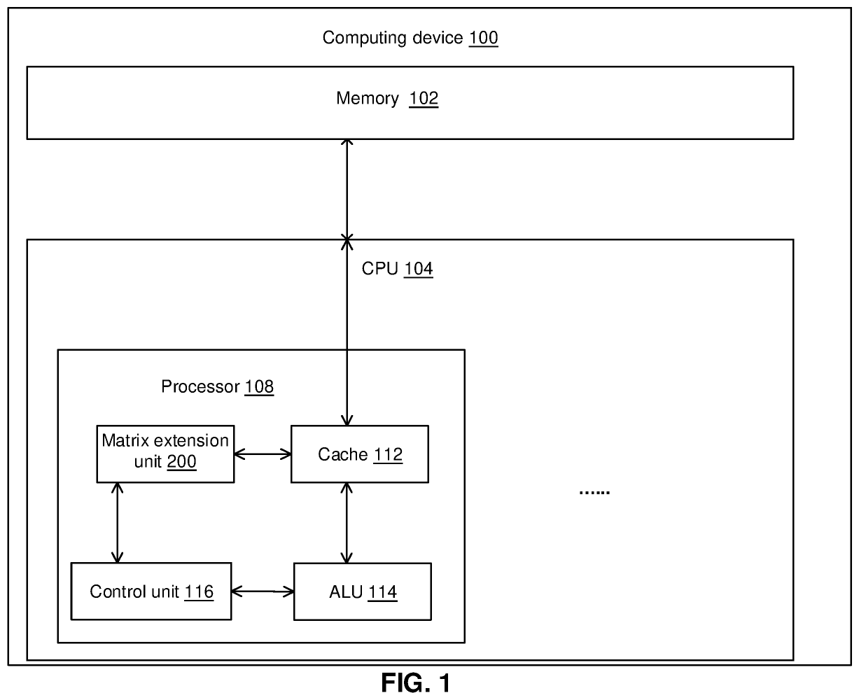

FIG. 1 illustrates an exemplary schematic diagram of a computing device 100 with floorplan-optimized matrix extension architecture, in accordance with some embodiments. The various components of the computing device 100 shown in FIG. 1 are intended to be illustrative. Depending on the implementation, the computing device 100 may include additional, fewer, or alternative components.

In some embodiments, the computing device 100 includes a memory 102 and a CPU 104 coupled to the memory 102. Each coupling described in this application (e.g., using the phrase “coupled to” or word “coupling”) may refer to a physical connection such as a wired connection or another connection that enables data communication between the coupled components.

In some embodiments, the CPU 104 may include one or more processors (e.g., processor cores). In FIG. 1, processor 108 of the one or more processors is shown. In one embodiment, other processors in the CPU 104 may each include similar components and have similar functions as the processor 108. The processor 108 may include a matrix extension unit 200, a cache 112 (e.g., a cache memory), an arithmetic logic unit (ALU) 114, and a control unit 116. The matrix extension unit 200 is described in further detail below. The control unit 116 may be configured to direct the operation of the CPU 104. For example, the control unit 116 may include and use a binary decoder circuit to convert coded instructions into timing and control signals that direct the operation of other units such as the memory 102, the ALU 114, etc. The ALU 114 may include a combinational digital circuit that performs arithmetic and bitwise operations on integer binary numbers. The memory 102 and the cache 112 may be used to store data. The matrix extension unit 200 may couple to the cache 112. The cache 112 may couple to the ALU 114. The control unit 116 may couple to the ALU 114. In one embodiment, the memory 102 may transmit data to the cache 112, and then the cache 112 may transmit the data to the matrix extension unit 200.

In some embodiments, more or fewer connections within the CPU 104 and from the CPU 104 may be configured. In one embodiment, the processor 108 is the CPU 104, and the CPU 104 includes the matrix extension unit 200, the cache 112, the arithmetic logic unit (ALU) 114, and the control unit 116.

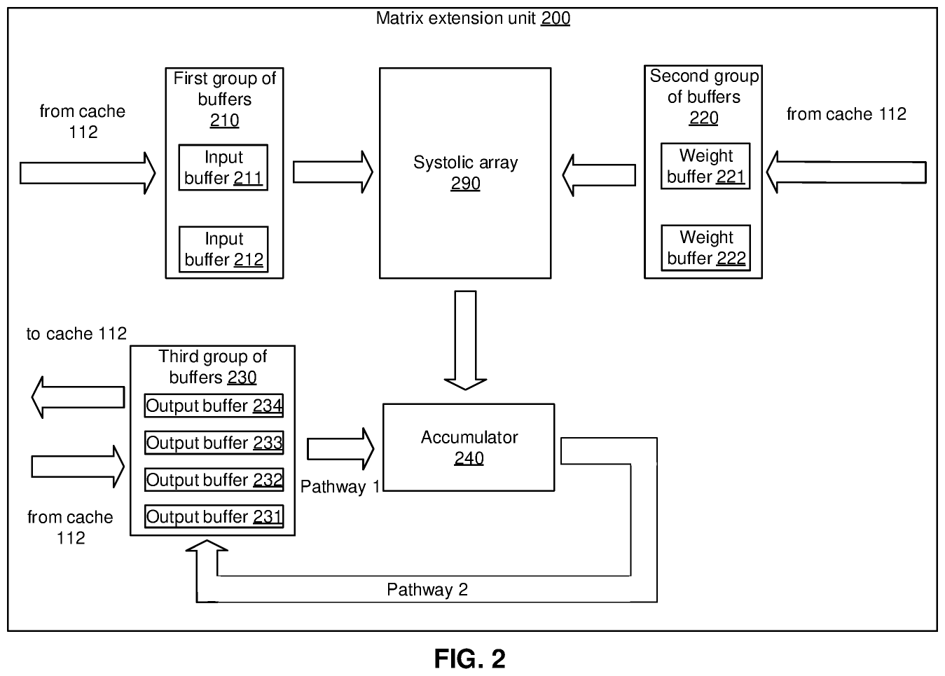

FIG. 2 illustrates an exemplary schematic diagram of a matrix extension unit 200, in accordance with some embodiments. The various components of the matrix extension unit 200 shown in FIG. 2 are intended to be illustrative. Depending on the implementation, the matrix extension unit 200 may include additional, fewer, or alternative components. As described earlier, the matrix extension unit 200 may be a part of the processor 108.

In some embodiments, the matrix extension unit 200 may include a systolic array of processing elements 290 and a first group of buffers 210 coupled to the systolic array 290. The first group 210 may include one or more first buffers (e.g., input buffer 211, input buffer 212). The matrix extension unit 200 may further include a second group of buffers 220 coupled to the systolic array 290. The second group 220 comprises one or more second buffers (e.g., weight buffer 221, weight buffer 222). The matrix extension unit 200 may further include an accumulator 240 coupled to the systolic array 290. The matrix extension unit 200 may further include a third group of buffers 230 coupled to the accumulator 240 (e.g., through two different pathways, pathway 1 and pathway 2, to form a loop connection). The third group may include one or more third buffers (e.g., output buffer 231, output buffer 232, output buffer 233, output buffer 234). Each of the first group of buffers 210, the second group of buffers 210, and the third group of buffers 230 may be configured to couple to the cache 112. The buffers 210, 220, 230 may be dedicated to serve the systolic array 290 and no other systolic array.

In some embodiments, each buffer may be a physical storage used to temporarily store data while it is being moved from one place to another. The accumulator may be a register in which intermediate arithmetic logic unit results are stored. The systolic array 290 may be in data communication with the first group of buffers 210, the second group of buffers 220, and the accumulators 240 only. The buffer, accumulator, and systolic array shall cover equivalent components that have different names.

In various embodiments, as explained further below, the disclosed floorplan of buffers may fix each buffer group to a specific connection with the systolic array or accumulator for providing a specific function. For example, the first group of buffers may be fixed to pipeline an input (e.g., input data) to the systolic array from one side of the systolic array, the second group of buffers may be fixed to preload another input (e.g., weight data) to the systolic array from a different side of the systolic array. The systolic array may use the inputs to perform calculations and output to an accumulator. The third group of buffers may be fixed to loop data with the accumulator and store intermediate values or final outputs of the calculation. This obviates many connections within the CPU. Accordingly, this floorplan design would improve PPA of the CPU.

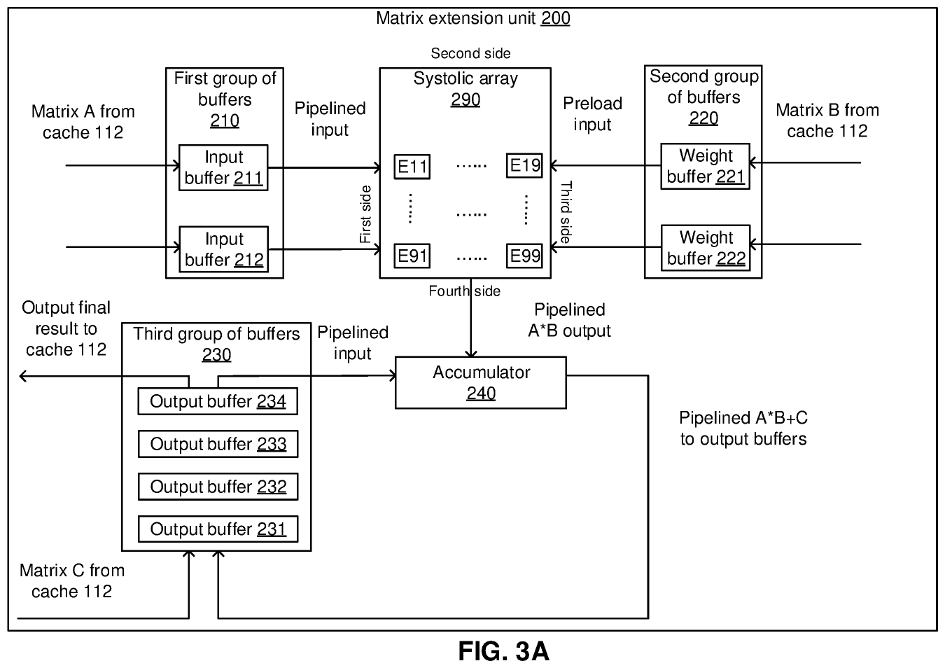

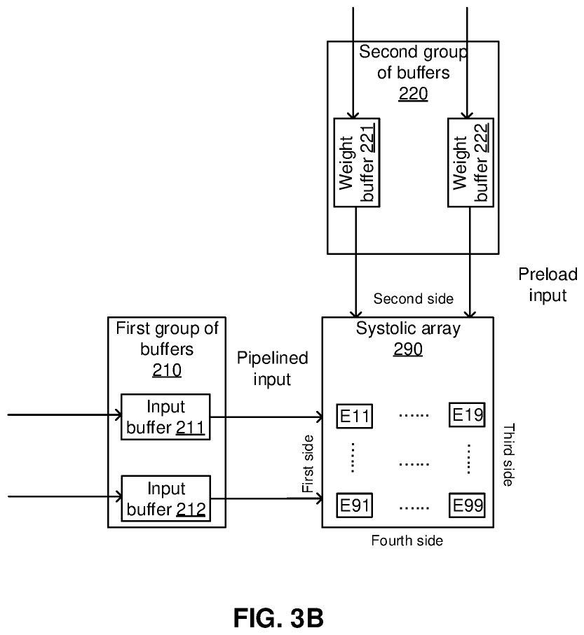

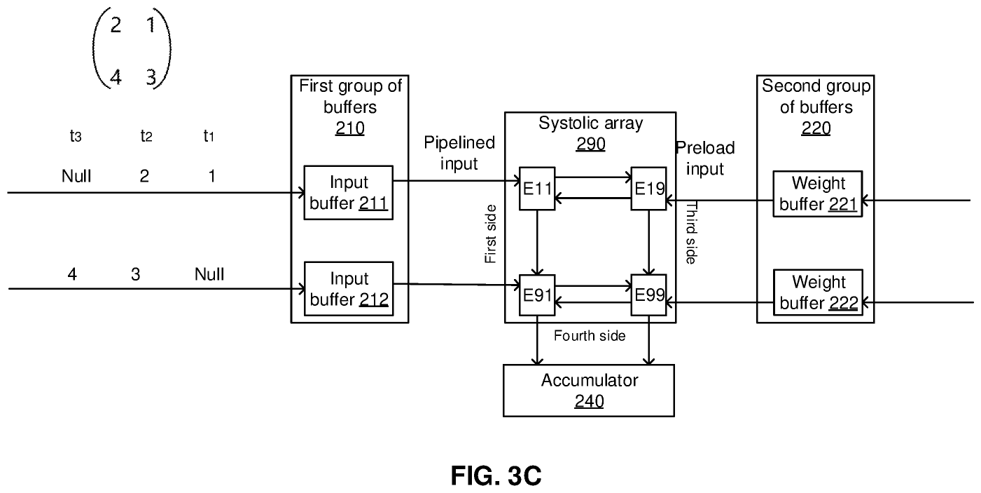

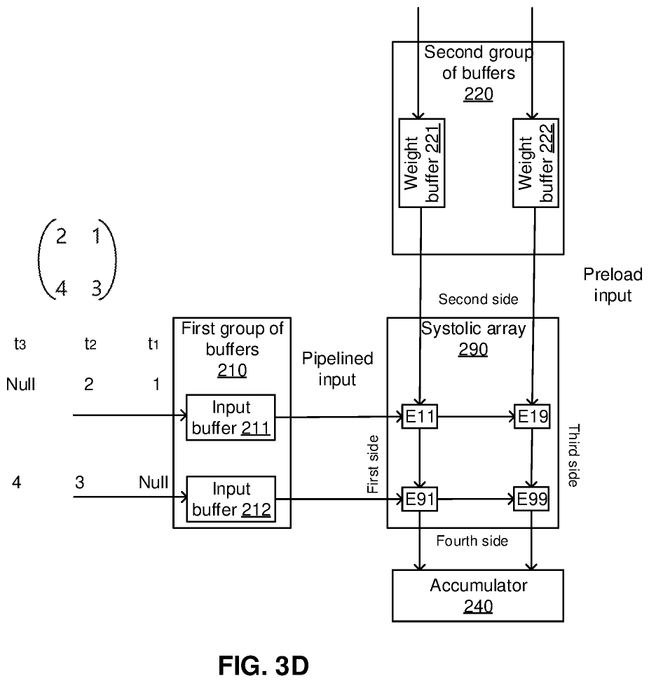

FIG. 3A to FIG. 3D describe various components of the matrix extension unit 200 and their functions. In various embodiments, two groups of input buffers (e.g., first group of buffers, second group of buffers) are configured to feed inputs of a calculation to a systolic array. The systolic array is configured to output a result of the calculation to an accumulator. A third group of buffers may couple to the accumulator and configured to store intermediate values or final outputs of the calculation.

FIG. 3A illustrates an exemplary schematic diagram of the matrix extension unit 200, in accordance with some embodiments. The various components of the matrix extension unit 200 shown in FIG. 3A are intended to be illustrative. Depending on the implementation, the matrix extension unit 200 may include additional, fewer, or alternative components.

FIG. 3A illustrates similar hardware components and connections as FIG. 2. In some embodiments, the matrix extension unit 200 has a floorplan-optimized matrix extension architecture including the systolic array 290, a plurality of buffers 210, 220, 230, and the accumulator 240. For example, the first group 210 includes two input buffers 211 and 212, the second group 220 includes two weight buffers 221 and 222, and the third group 230 includes four output buffers 231, 232, 233, and 234.

In some embodiments, the first group 210 includes a first plurality of buffers (e.g., input buffers 211 and 212) individually coupled to the systolic array, and the second group 220 includes a second plurality of buffers (e.g., weight buffers 221 and 222) individually coupled to the systolic array. That is, the first plurality of buffers are coupled in parallel to the systolic array (that is, the first plurality of buffers, in parallel to each other, may couple into the systolic array from a first side of the systolic array, and the first plurality of buffers are respectively coupled to a line of processing elements at the first side of the systolic array), and the second plurality of buffers are coupled in parallel to the systolic array (that is, the second plurality of buffers, in parallel to each other, may couple into the systolic array from a different side of the systolic array, and the second plurality of buffers are respectively coupled to a line of processing elements at the different side of the systolic array). The parallel coupling within each group of buffers enables each buffer with the same group to feed a stream data into the systolic array in parallel but staggered in time, as the each buffer receives data from a cache. The coupling of different groups of buffers from different sides of the systolic array optimizes space utilization and data transmission without interference.

In some embodiments, the systolic array includes a two-dimensional array (e.g., 2 by 2, 2 by 3, 3 by 3, etc.) of processing elements. In one embodiment, each processing element may be a data processing unit (DPU) (also known as channel controller), which is a specialized electronic circuit with hardware acceleration of data processing for data-centric computing. For example, the array may include a 2 by 2 array of processing elements E11, E19, E91, and E99. As shown in FIG. 3A, the two-dimensional array corresponds to a first side, a second side, a third side opposite to the first side, and a fourth side opposite to the second side. The first and third sides are substantially parallel to columns of the array, and the second and fourth sides are substantially parallel to rows of the array. In one embodiment, the first plurality of buffers (e.g., input buffers 211 and 212) are individually coupled to the first side and not coupled to the second side, the third side, and the fourth side. In one embodiment, the second plurality of buffers (e.g., weight buffers 221 and 222) are individually coupled to the third side (e.g., as shown in FIG. 3A) and not coupled to the first side and the fourth side.

In some embodiments, alternative to the configuration shown in FIG. 3A, the second plurality of buffers (e.g., weight buffers 221 and 222) may be individually coupled to the second side (e.g., as shown in FIG. 3B) and not coupled to the first side and the fourth side. FIG. 3B illustrates an exemplary schematic diagram of buffer coupling, in accordance with some embodiments. The coupling between the systolic array 290 and the second group of buffers 220 in FIG. 3A may be replaced with that shown in FIG. 3B, while other components of the matrix extension unit 200 remain unchanged.

In one embodiment, the accumulator is coupled to the fourth side and not coupled to the first side, the second side, and the third side. In one embodiments, the positions of the first, second, and third plurality of buffers and the accumulator relative to the systolic array may be fixed. For example, the first and second plurality of buffers and the accumulator are disposed at three different sides of the systolic array, with the first and second plurality of buffers on opposite sides. The plurality of buffers are disposed to form a loop with the accumulator. As such, the positions of the first and second plurality of buffers and the accumulator surround the systolic array, which efficiently use the space, avoid congregation, and facilitate flow of data into the array from two sides (e.g., the left and right sides) and out from another side (e.g., the bottom side) of the array.

In some embodiments, the first plurality of buffers are individually coupled to one or more caches (e.g., cache 112) of the processor 108; and the second plurality of buffers are individually coupled to the one or more caches of the processor. This parallel connection between the buffers and the cache may be similar to the parallel connection between the buffers and the systolic array. In one embodiment, the first plurality of buffers are configured to obtain first input data (e.g., matrix A) from the one or more caches of the processor and to transmit the first input data to the systolic array; and the first plurality of buffers are configured to, in parallel and staggered in time, each transmit a portion of the first input data the systolic array. Referring to FIG. 3C and FIG. 3D, FIG. 3C and FIG. 3D illustrate exemplary schematic diagrams of pipelined input, in accordance with some embodiments. FIG. 3C corresponds to the configuration of second group of buffers shown in FIG. 3A, and FIG. 3D corresponds to the configuration of second group of buffers shown in FIG. 3B. For both FIG. 3C and FIG. 3D, for example, an pipelined input (e.g., matrix A) as shown is a matrix

$$( \begin{matrix}2 & 1 \\ 4 & 3\end{matrix} ) .$$

At time t1, the input buffers have been preloaded with weight data from the second group of buffers 220. That is, processing elements E11, E19, E91, and E99 have received corresponding weight data from the second group of buffers from either of the configurations shown in FIG. 3C (from weight buffer 221 to E19 to E11; from weight buffer 222 to E99 to E91) and FIG. 3D (from weight buffer 221 to E11 to E91; from weight buffer 222 to E19 to E99). For example, the weight data may include a matrix B, and each element of the matrix B is sent to a corresponding processing element. Once the weight data is loaded, the following calculation applies to both FIG. 3C and FIG. 3D similarly. The first group of buffers 210 may send input data into the systolic array 290. For example, at time t1, input data (1, null) is sent to (E11, E91), that is, input buffer 211 may feed data 1 to processing element E11. E11 may receive the input data 1 and perform a calculation (e.g., multiplication) based on the input data and the weight data. A result of the calculation may be sent to the accumulator 240. Right next at time t2, (1, null) is passed down to (E19, E99), and input data (2, 3) is sent to (E11, E91), that is input buffer 211 may feed data 2 to processing element E11, and input buffer 212 may feed data 3 to processing element E91. The processing elements perform corresponding calculations and pass the results to the accumulator. Right next at time t3, (2, 3) is passed down to (E19, E99), and input data (null, 4) is sent to (E11, E91), that is input buffer 212 may feed data 4 to processing element E91. The processing elements perform corresponding calculations and pass the results to the accumulator. In some embodiments, the transmission of data in parallel and staggered in time may be referred to as pipeline. That is, the first plurality of buffers may be configured to pipeline input data into the systolic array. For each processing element, the accumulator may add up the results of calculations to obtain an element of an output of the calculation (e.g., a multiplication of matrix A and matrix B). The output of the calculation will include such elements from all of the processing elements.

Referring back to FIG. 3A, In some embodiments, the second plurality of buffers are configured to obtain weight data (e.g., weights for matrix B containing various weights) from the one or more caches of the processor and to preload the weight data into the systolic array. The weight data may be preloaded in parallel. For example, weight buffer 221 may preload to processing element E19, and weight buffer 222 may preload to processing element E99. The preloading may or may not be staggered in time. In some embodiments, preloading may be achieved by broadcasting. That is, the second plurality of buffers may be configured to broadcast weight data into the systolic array.

In some embodiments, the systolic array is configured to obtain the weight data from the second plurality of buffers before obtaining the first input data from the first plurality of buffers. That is, the weight data may be preloaded as stationary values before the first input data is fed into the systolic array. In some embodiments, the systolic array is configured to compute based on the first input data and the weight data and to, in parallel and staggered in time, transmit output data to the accumulator. For example, the computation may be multiplying matrix A with matrix B. Since the input data is fed into the systolic array 290 in parallel and staggered in time, the output data (various intermediary results from the multiplication matrix A with matrix B) generated from the systolic array is in parallel and staggered in time. The output data is looped through the third group of buffers 230 and back to the accumulator 240 to obtain a final result of the multiplication matrix A with matrix B.

In some embodiments, the third group 230 includes a third plurality of buffers (e.g., output buffer 231, 232, 233, 234) coupled to (i) the accumulator 240 and (ii) one or more caches (e.g., cache 112) of the processor 108. In one embodiment, the third plurality of buffers are connected in series within the third group, and therefore just one connection from the last buffer (e.g., output buffer 234) to the accumulator 240 is needed to feedback data, and the feedback speed is faster while consuming less power. As such, less connections are required which saves space and improves the PPA. The third plurality of buffers 230 and the accumulator 240 form a loop as the accumulator 240 connects to the buffers 230 and the buffers 230 connect back to the accumulator 240.

In some embodiments, the third group of buffers may include one or more third buffers configured to transmit second input data to the accumulator 240 via a first pathway of a data transmission loop (e.g., pathway 1) and receive results from the accumulator 240 via a second pathway of the data transmission loop (e.g., pathway 2). In one embodiment, the third plurality of buffers 230 are configured to obtain second input data (e.g., matrix C, which may be a bias matrix) from the one or more caches of the processor, and transmit the second input data to the accumulator 240. The accumulator 240 may be configured to recursively generate an intermediary result based on output data from the systolic array 290 and the second input data, and transmit the intermediary result to the third plurality of buffers 230. The third plurality of buffers 230 may be configured to feedback the intermediary result to the accumulator 240; and the accumulator 240 is configured to recursively update the intermediary result based on the output data and the feedback intermediary result and transmit the updated intermediary result to the third plurality of buffers 230 until obtaining a final element of a final result (e.g., a resultant matrix of A*B+C). The third plurality of buffers 230 are configured to each store the last updated intermediary result, and output the final result comprising the last updated intermediary results to the one or more caches of the processor.

In some embodiments, the first plurality of buffers are configured to obtain a first matrix A and feed the first matrix A to the systolic array; the second plurality of buffers are configured to obtain a second matrix B and feed the second matrix B to the systolic array; the systolic array is configured to multiply the first matrix A and the second matrix B to output A*B to the accumulator; the accumulator is configured to obtain a third matrix C from the third plurality of buffers and generate a result of A*B+C through a plurality of loops of recursive calculations; and the third plurality of buffers are configured to obtain and output the result of A*B+C.

As described above, in various embodiments, unlike the outer-product architecture or other parallel architectures employing a lattice of processing elements, a systolic array may be characterized by a regular data flow where two or more data streams flow through the processing elements of the systolic array with various speeds and directions. Data items from different streams interact with each other and trigger computations in the processing elements where they meet. Thus, a systolic array simultaneously exploits both pipelining and parallelism. In some embodiments, the buffers may be grouped into the first group corresponding to input data, the second group corresponding to weights, and the third group corresponding to output data. The three groups each may have a specific physical location relative to the systolic array, specific connections to components of the CPU, and a specific function and do not conflict with one another. Further, the floorplan becomes more compact with grouped buffers with each group placed on a different side of systolic array according to the function. Every group of buffers has a different function, which obviates some switching multiplexers (MUXs). The PPA may be improved because wires between buffers and systolic array may be routed with a shorter average distance.

Further, in various embodiments, the accumulator may improve data reuse of the third group of buffers by forming a loop with the third group of buffers. The use of the accumulator obviates the adders for bias matrix adding, and half input wires of the systolic array can be moved to the accumulator. As such, the groups of buffers and the accumulator are optimized for computations such as matrix multiplication. The disclosed architecture may facilitate efficient data reuse and achieve a compact floorplan, resulting in a better PPA. For example, by requiring fewer connections and components, the floorplan-optimized matrix extension architecture may take up less area or space in the CPU, consume less power, have a faster computing speed, and be optimized for 2×2=4 sub-matrix outer-product calculation C=A*B+C.

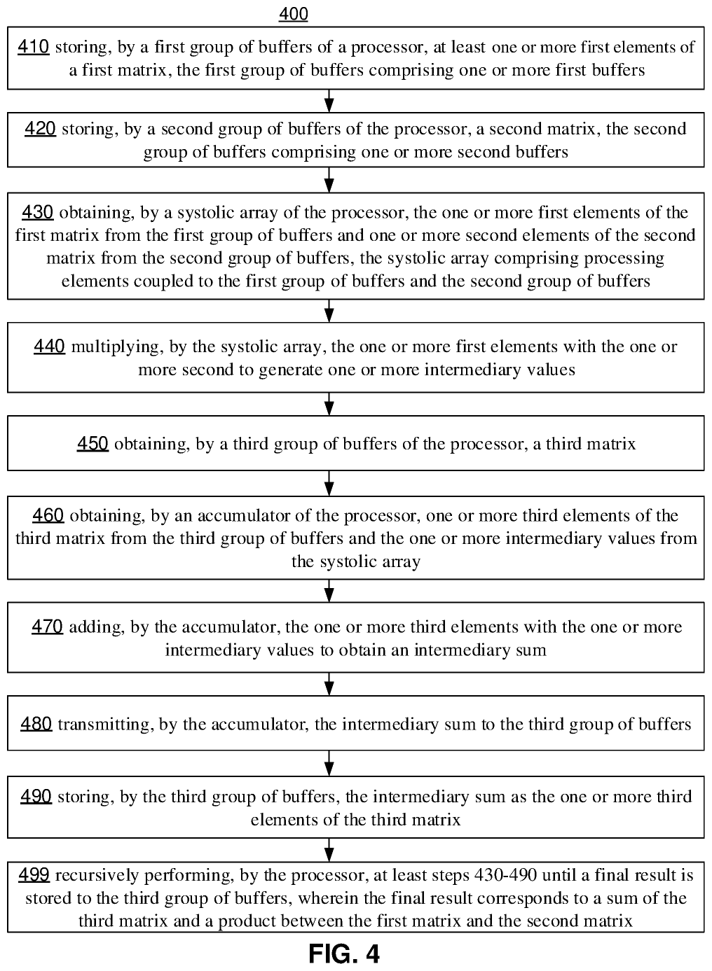

FIG. 4 illustrates an exemplary method of performing matrix computation, in accordance with some embodiments. The method 400 may be implemented in an environment shown in FIG. 1. The method 400 may be performed by a device, apparatus, or system illustrated by FIGS. 1-3, such as the computing device 100, the CPU 104, or the processor 108. Depending on the implementation, the method 400 may include additional, fewer, or alternative steps performed in various orders or parallel. All of the embodiments described above including structures, connections, steps, technical effects, and benefits described with reference to FIGS. 1-3 may be applied to, carried over to, and modified and combined with the description of FIG. 4.

The method 400 may include steps 410-499.

Step 410 may include storing, by a first group of buffers of a processor, at least one or more first elements of a first matrix, the first group of buffers comprising one or more first buffers. For example, the first matrix A has various elements A[i,k], where i and k are row and column indices. For a 2 by 2 matrix, A would have four elements A[1,1], A[1,2], A[2,1], and A[2,2].

Step 420 may include storing, by a second group of buffers of the processor, at least one or more second elements of a second matrix, the second group of buffers comprising one or more second buffers. For example, the second matrix B has various elements B[k,j], where k and j are row and column indices.

Step 430 may include obtaining, by a systolic array of the processor, the one or more first elements of the first matrix from the first group of buffers and the one or more second elements of the second matrix from the second group of buffers, the systolic array comprising processing elements coupled to the first group of buffers and the second group of buffers. In some embodiments, the systolic array is configured to obtain the one or more second elements from the second group of buffers before obtaining the one or more first elements from the first group of buffers. That is, the one or more second elements may be preloaded as stationary values before the one or more first elements are fed into the systolic array.

Step 440 may include multiplying, by the systolic array, the one or more first elements with the one or more second to generate one or more intermediary values.

Step 450 may include obtaining, by a third group of buffers of the processor, a third matrix. For example, the third matrix C has various elements C[i,j], where i and j are row and column indices.

Step 460 may include obtaining, by an accumulator of the processor, one or more third elements of the third matrix from the third group of buffers and the one or more intermediary values from the systolic array.

Step 470 may include adding, by the accumulator, the one or more third elements with the one or more intermediary values to obtain an intermediary sum.

Step 480 may include transmitting, by the accumulator, the intermediary sum to the third group of buffers.

Step 490 may include storing, by the third group of buffers, the intermediary sum as the one or more third elements of the third matrix.

Step 499 may include recursively performing, by the processor, steps 410-490 until a final result is stored to the third group of buffers, wherein the final result corresponds to a sum of the third matrix and a product between the first matrix and the second matrix (e.g., first matrix A*second matrix B+third matrix C). For example, C[i, j]+=A[i,k]*B[k,j] is recursively computed through three layers of nested loops with a first loop looping through i, a second loop looping through j, and a third loop looping through k. Thus, the final result produced by the processor may be the result of A*B+C.

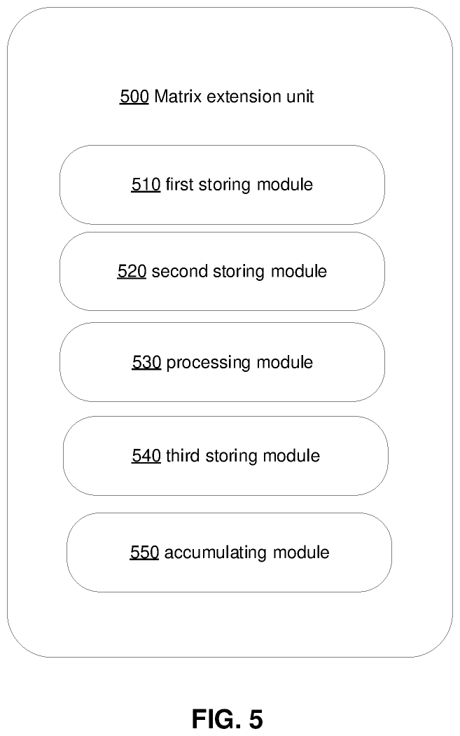

FIG. 5 illustrates an exemplary block diagram of a matrix extension unit 500, in accordance with some embodiments. The components of the matrix extension unit 500 presented below are intended to be illustrative. Depending on the implementation, the matrix extension unit 500 may include additional, fewer, or alternative components. The matrix extension unit 500 may be implemented by the matrix unit 200 described above. All of the embodiments described above including structures, connections, steps, technical effects, and benefits described with reference to FIGS. 1-4 may be applied to, carried over to, and modified and combined with the description of FIG. 5.

In some embodiments, the matrix extension unit 500 may include a first storing module 510 (e.g., first group of buffers 210) for storing at least one or more first elements of a first matrix, a second storing module 520 (e.g., second group of buffers 220) for storing at least one or more second elements of a second matrix, a processing module 530 (e.g., systolic array 290) for obtaining the one or more first elements of the first matrix from the first storing module 510 and the one or more second elements of the second matrix from the second storing module 520, and multiplying the one or more first elements with the one or more second to generate one or more intermediary values.

In some embodiments, the matrix extension unit 500 may further include a third storing module 540 (e.g., third group of buffers 230) for obtaining a third matrix, an accumulating module 550 (e.g., accumulator 240) for obtaining one or more third elements of the third matrix from the third storing module 540 and the one or more intermediary values from the processing module 530, adding the one or more third elements with the one or more intermediary values to obtain an intermediary sum, and transmitting the intermediary sum to the third storing module 540.

In some embodiments, the third storing module 540 may be for storing the intermediary sum as the one or more third elements of the third matrix.

In some embodiments, the first storing module 510, the second storing module 520, the processing module 530, and the third storing module 540 may be for recursively performing the above steps described with respect to FIG. 5 until a final result is stored to the third group. The final result corresponds to a sum of the third matrix and a product between the first matrix and the second matrix (e.g., first matrix A*second matrix B+third matrix C).

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuit.

When the functions disclosed herein are implemented in the form of software functional units and sold or used as independent products, they can be stored in a processor executable non-volatile computer-readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server, or a server group (hereinafter collectively the “service system”) that interacts with a client. The client may be a terminal device, or a client registered by a user at a platform, where the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner Blocks or states may be added to or removed from the disclosed example embodiments. The exemplary systems and components described herein may be configured differently than described. For example, elements may be added to, removed from, or rearranged compared to the disclosed example embodiments.

The various operations of example methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a prediction model that performs the function.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or sections of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

1. A processor, comprising:
a systolic array of processing elements;
a first group of buffers coupled to the systolic array, wherein the first group comprises one or more first buffers;
a second group of buffers coupled to the systolic array, wherein the second group comprises one or more second buffers;
an accumulator coupled to the systolic array; and
a third group of buffers coupled to the accumulator, wherein the third group comprises one or more third buffers.

2. The processor of claim 1, wherein the processor is a central processing unit (CPU).

3. The processor of claim 1, wherein:
the first group comprises two buffers, the second group comprises two buffers, and the third group comprises four buffers.

4. The processor of claim 1, wherein:
the first group comprises a first plurality of buffers individually coupled to the systolic array; and
the second group comprises a second plurality of buffers individually coupled to the systolic array.

5. The processor of claim 4, wherein:
the systolic array is a two-dimensional array;
the two-dimensional array corresponds to a first side, a second side, a third side opposite to the first side, and a fourth side opposite to the second side; and
the first plurality of buffers are individually coupled to the first side and not coupled to the second side, the third side, and the fourth side.

6. The processor of claim 5, wherein:
the second plurality of buffers are individually coupled to the second side or third side and not coupled to the first side and the fourth side.

7. The processor of claim 5, wherein:
the accumulator is coupled to the fourth side and not coupled to the first side, the second side, and the third side.

8. The processor of claim 4, wherein:
the first plurality of buffers are individually coupled to one or more caches of the processor; and
the second plurality of buffers are individually coupled to the one or more caches of the processor.

9. The processor of claim 8, wherein:
the first plurality of buffers are configured to obtain first input data from the one or more caches of the processor and to transmit the first input data to the systolic array; and
the first plurality of buffers are configured to, in parallel and staggered in time, each transmit a portion of the first input data the systolic array.

10. The processor of claim 9, wherein:
the second plurality of buffers are configured to obtain weight data from the one or more caches of the processor and to preload the weight data into the systolic array.

11. The processor of claim 10, wherein:
the systolic array is configured to compute based on the first input data and the weight data and to, in parallel and staggered in time, transmit output data to the accumulator.

12. The processor of claim 4, wherein:
the third group comprises a third plurality of buffers coupled to (i) the accumulator and (ii) one or more caches of the processor.

13. The processor of claim 12, wherein:
the first plurality of buffers are coupled in parallel to the systolic array;
the second plurality of buffers are coupled in parallel to the systolic array;
the third plurality of buffers are connected in series within the third group; and
the third plurality of buffers and the accumulator form a loop.

14. The processor of claim 13, wherein:
the third plurality of buffers are configured to:
obtain second input data from the one or more caches of the processor, and
transmit the second input data to the accumulator; and
the accumulator is configured to:
recursively generate an intermediary result based on output data from the systolic array and the second input data, and
transmit the intermediary result to the third plurality of buffers.

15. The processor of claim 14, wherein:
the third plurality of buffers are configured to feedback the intermediary result to the accumulator; and
the accumulator is configured to recursively update the intermediary result based on the output data and the feedback intermediary result and transmit the updated intermediary result to the third plurality of buffers.

16. The processor of claim 15, wherein the third plurality of buffers are configured to:
each store a last updated intermediary result; and
output a final result comprising the last updated intermediary results to the one or more caches of the processor.

17. The processor of claim 13, wherein:
the first plurality of buffers are configured to obtain a first matrix A and feed the first matrix A to the systolic array;
the second plurality of buffers are configured to obtain a second matrix B and feed the second matrix B to the systolic array;
the systolic array is configured to multiply the first matrix A and the second matrix B to output A*B to the accumulator;
the accumulator is configured to obtain a third matrix C from the third plurality of buffers and generate a result of A*B+C through a plurality of loops of recursive calculations; and
the third plurality of buffers are configured to obtain and output the result of A*B+C.

18. A computing device, comprising a memory and a processor coupled to the memory, wherein the processor comprises:
a systolic array of processing elements;
a first group of buffers coupled to the systolic array, wherein the first group comprises one or more first buffers configured to pipeline first input data into the systolic array;
a second group of buffers coupled to the systolic array, wherein the second group comprises one or more second buffers configured to broadcast weight data into the systolic array;
an accumulator coupled to the systolic array and configured to receive output data from the systolic array; and
a third group of buffers comprising one or more third buffers configured to transmit second input data to the accumulator via a first pathway of a data transmission loop and receive results from the accumulator via a second pathway of the data transmission loop.

19. The computing device of claim 18, wherein the third group of buffers are coupled to a cache of the processor.

20. A method, comprising:
(1) storing, by a first group of buffers of a processor, at least one or more first elements of a first matrix, the first group of buffers comprising one or more first buffers;
(2) storing, by a second group of buffers of the processor, at least one or more second elements of a second matrix, the second group of buffers comprising one or more second buffers;
(3) obtaining, by a systolic array of the processor, the one or more first elements of the first matrix from the first group of buffers and the one or more second elements of the second matrix from the second group of buffers, the systolic array comprising processing elements coupled to the first group of buffers and the second group of buffers;
(4) multiplying, by the systolic array, the one or more first elements with the one or more second to generate one or more intermediary values;
(5) obtaining, by a third group of buffers of the processor, a third matrix;
(6) obtaining, by an accumulator of the processor, one or more third elements of the third matrix from the third group of buffers and the one or more intermediary values from the systolic array;
(7) adding, by the accumulator, the one or more third elements with the one or more intermediary values to obtain an intermediary sum;
(8) transmitting, by the accumulator, the intermediary sum to the third group of buffers;
(9) storing, by the third group of buffers, the intermediary sum as the one or more third elements of the third matrix; and
(10) recursively performing, by the processor, steps (1)-(9) until a final result is stored to the third group of buffers, wherein the final result corresponds to a sum of the third matrix and a product between the first matrix and the second matrix.
